(19) United States
(12) Patent Application Publication
(10) Pub. No.: US 2002/0036458 A1
(43) Pub. Date: Mar. 28, 2002

(54) Device for fixing shadow mask of flat CRT

(75) Inventor: Ki Bum Park, Kyungsan (KR)

Correspondence Address: FLESHNER & KIM, LLP, P.O. Box 221200, Chantilly, VA, 20153-1200, US

(73) Assignee: LG Electronics Inc.

(21) Appl. No.: 09/855,524

(22) Filed: May 16, 2001

(30) Foreign Application Priority Data
May 17, 2000 (KR) 26437/2000

(51) Int. Cl. H01J 29/80; H01J 1/62; H01J 63/04

(52) U.S. Cl. 313/495; 313/402

(57) ABSTRACT

In a device for fixing a shadow mask placed between a panel and a shadow mask of a flat CRT (Cathode Ray Tube) and adhered to the panel by a bonding member so as to maintain a constant distance between the panel and the shadow mask, an optimum width of a device for fixing a shadow mask can be calculated in accordance with a tensile force worked on the shadow mask or a variation of a height of the device itself, and a permitted limit of a width of the device can be provided.

### BACKGROUND OF THE INVENTION

1. Field of the Invention

The present invention relates to a flat CRT (Cathode Ray Tube), and in particular to a device for fixing a shadow mask of a flat CRT

2. Description of the Prior Art

As depicted in FIG. 1, a flat CRT (Cathode Ray Tube) includes a flat-shaped panel 10, a R·G·B (Red, Green, Blue) three-colored fluorescent screen 20 coated at an inner surface of a panel 10, a safety glass 30 fixed to a front surface of the panel 10 and improving an explosion proof characteristic of the panel 10, a funnel 40 in a vacuum state which is fusion-welded at a back surface of the panel 10 by a frit glass as a bonding member, an electron gun 50 enclosed in a neck portion 41 of the funnel 40 and radiating an electron beam to the fluorescent screen side, a shadow mask 60 installed near to the fluorescent screen 20 and performing a color selection of an electron beam radiated from the electron gun 50, and a magnetic field shield 90 protecting an electron beam proceeding toward the fluorescent screen 20 from an external magnetic field.

When power is applied to a flat CRT, an electron beam is radiated from the electron gun 50 enclosed in the neck portion 41 of the funnel 40, the radiated electron beam is being accelerated and focused while passing through a plurality of electrodes, colors of the electron beam are sorted out while passing through a plurality of holes 61 formed on the shadow mask 60, and the electron beam hits the fluorescent screen 20 coated at the inner surface of the panel 10. Accordingly a picture can be displayed.

In the meantime, between the panel 10 and shadow mask 60, a device for fixing a shadow mask 70 supporting the shadow mask 60 so as to maintain a certain distance from an inner surface of the panel 10 is fixed to the inner surface of the panel 10.

As depicted in FIG. 2, the device for fixing the shadow mask 70 is fusion-welded and fixed to the panel 10 by a frit glass 80 filled inside the device for fixing the shadow mask 70 itself.

Each edge of the shadow mask 60 is fixed to an upper surface of the device for fixing the shadow mask 70 by a fusion processing such as a welding, etc., accordingly a certain distance between the panel 10 and the shadow mask 60 can be maintained.

The shadow mask 60 is fixed to the device for fixing the shadow mask 70 with a tensile force W worked on each end of the shadow mask 60, and the tensile force W is maintained as it is after the fixation by support of the device for fixing the shadow mask 70.

Accordingly, the tensile force W worked on the shadow mask 60 can be changed in accordance with variation of a width of the shadow mask 60, an elastic modulus of materials of the shadow mask, etc., when a height of the device for fixing the shadow mask 70 is changed, a bearing force of the device for fixing the shadow mask 70 should be also changed.

However, the device for fixing the shadow mask 70 in accordance with the prior art has the below problems.

In a general flat CRT manufacturing process, because the variation of a bearing force of the device for fixing the shadow mask 70 is not considered, when a tensile force W of the shadow mask 60 is bigger than a bearing force of the device for fixing the shadow mask 70, a center portion of the panel 10 can be deformed, accordingly the shadow mask 60 can not maintain horizontality.

And, because the position of the plurality of holes 61 formed on the shadow mask 60 can be changed, colors of a picture displayed on a screen can be changed or mixed, in other words, a mislanding phenomenon can be occurred in the conventional flat CRT.

In addition, because the frit glass 80 filled inside the device for fixing the shadow mask 70 can not stand out the tensile force W acted on the shadow mask 60, the frit glass 80 can be cracked, accordingly it can deteriorate products.

### SUMMARY OF THE INVENTION

In order to solve the above-mentioned problems, in a device for fixing a shadow mask placed between a panel of a flat CRT (Cathode Ray Tube) and a shadow mask and attached to the panel by a bonding member in order to maintain a certain distance between the panel and the shadow mask, an object of the present invention is to provide a device for fixing a shadow mask which is capable of maintaining the horizontality of the shadow mask by calculating an optimum width of a device for fixing a shadow mask in accordance with a tensile force acted on the shadow mask or a variation of its height and providing a permitted limit of the optimum width.

In order to achieve the object of the present invention, there is provided a device for fixing a shadow mask varying a width of a portion attached to a panel in accordance with its height and a tensile force acted on the shadow mask in order to keep a bearing force appropriate to its height and a tensile force acted on the shadow mask.

### BRIEF DESCRIPTION OF THE DRAWINGS

FIG. 1 is a sectional view illustrating a conventional flat CRT (Cathode Ray Tube).

FIG. 2 is a sectional view illustrating a device for fixing a shadow mask of a conventional flat CRT (Cathode Ray Tube).

FIG. 3 is a sectional view illustrating a device for fixing a shadow mask of a flat CRT (Cathode Ray Tube) in accordance with an embodiment of the present invention.

FIG. 4 is a sectional view illustrating a device for fixing a shadow mask of a flat CRT (Cathode Ray Tube) in accordance with another embodiment of the present invention.

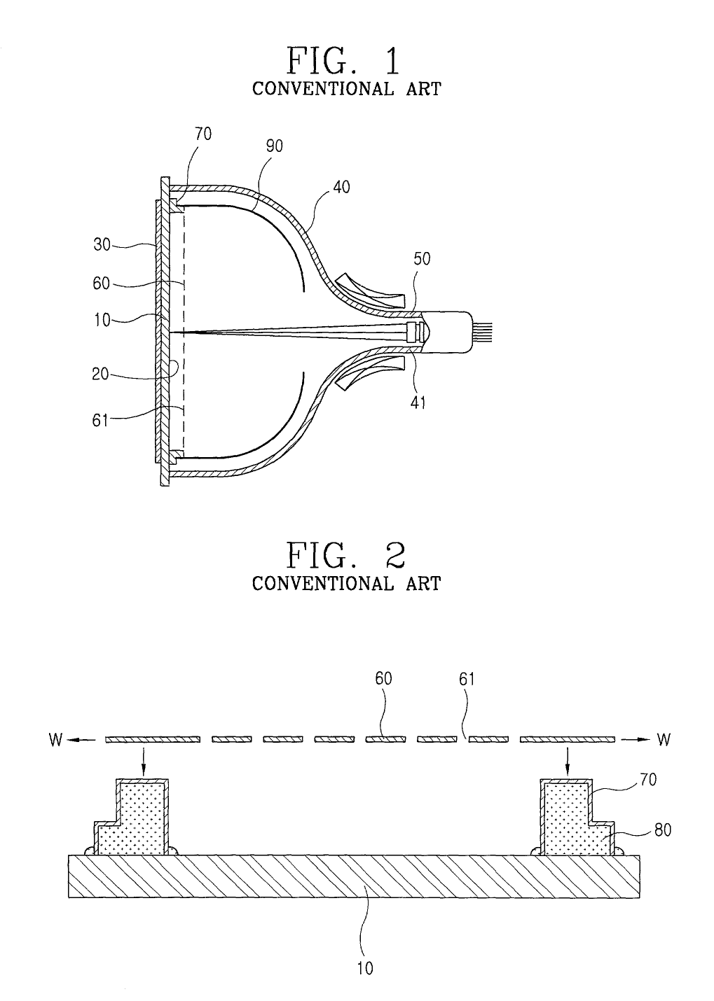

### DETAILED DESCRIPTION OF THE PREFERRED EMBODIMENT

Hereinafter, the embodiments of the present invention will now be described with reference to the accompanying drawings, and the same parts as the prior art will have the same reference numbers.

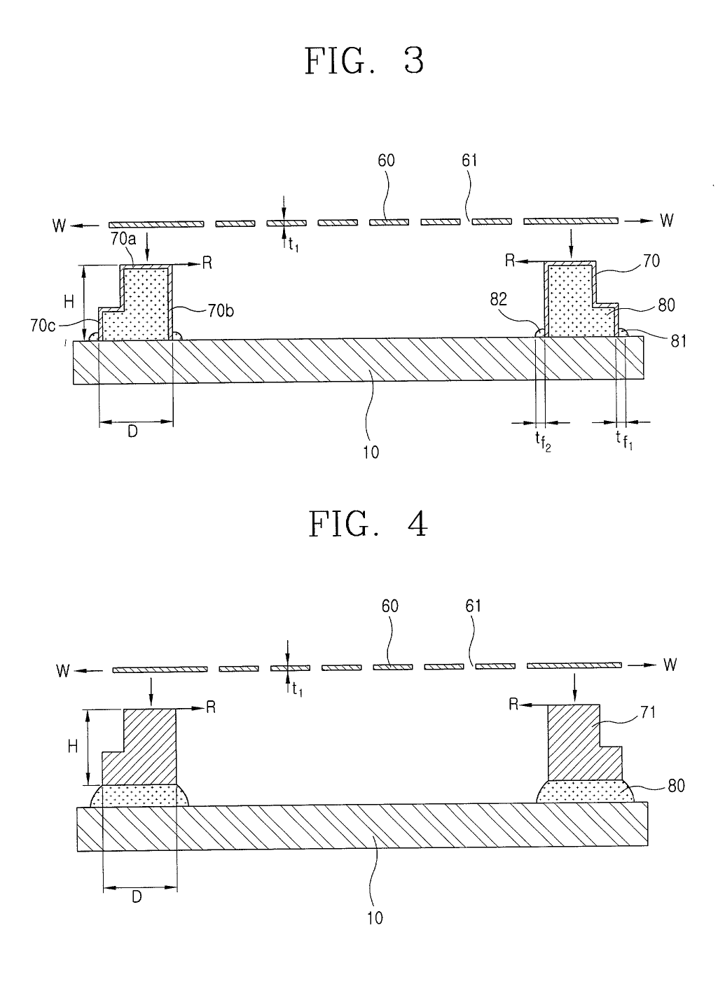

As depicted in FIG. 3, a device for fixing a shadow mask 70 in accordance with the present invention is a thin plate bent a certain times and its bottom portion is open.

A high-temperature frit glass 80 in a fusion state is filled inside the device for fixing the shadow mask 70 as a bonding member and solidified on a surface of a panel 10, accordingly the shadow mask 70 is attached and fixed to the panel 10, its fixation state is symmetric.

In more detail, when the high-temperature frit glass 80 in the fusion state is filled inside the device for fixing the shadow mask 70 and a lower portion of the device for fixing the shadow mask 70 is placed on a certain portion of a upper surface of the panel 10, because the frit glass 80 is solidified as its temperature lowers, the device for fixing the shadow mask is attached to the panel 10.

In the meantime, the shadow mask 60 is fixed to a upper surface of the device for fixing the shadow mask 70 attached to the panel 10 in a tensile force-acted state, and the shadow mask 60 maintains a tensioned state by the support of the device for fixing the shadow mask 70.

However, the shadow mask 60 tends to return to a state before the tensioned state due to an elastic restoring force of its material, it works on the device for fixing the shadow mask 70 as a supporting force R.

A magnitude of the supporting force R worked on the device for fixing the shadow mask 70 is same as a magnitude of a tensile force W worked on the shadow mask 60, and a direction of the supporting force R is opposite to a direction of the tensile force W worked on the shadow mask 60.

The device for fixing the shadow mask 70 tends to deform due to the supporting force R, however the deformation is prevented by its bearing force based on the frit glass 80 which is filled inside of the device for fixing the shadow mask 70 itself and performs a bonding member function between the panel 10 and device for fixing the shadow mask 70.

Accordingly, when the bearing force of the device for fixing the shadow mask 70 based on the strength of the frit glass 80 stands out the supporting force R, the tensile force W acted on the shadow mask 60 and the supporting force R acted on the device for fixing the shadow mask 70 are balanced, accordingly the tensioned state of the shadow mask 60 can be maintained.

In the meantime, when the tensile force W acted on the shadow mask 60 is getting bigger due to variation of a width or a strain of the shadow mask 60, the bearing force of the device for fixing the shadow mask 70 also has to be getting bigger in order to balance both the tensile force W and supporting force R, nevertheless the frit glass 80 has a constant strength of 7.46 N/mm² in general.

Accordingly, a width D of a portion of the device for fixing the shadow mask 70 attached to the panel 10 not only has to be minimized but also has to maintain the sufficient bearing force of the device for fixing the shadow mask 70 based on the frit glass 80.

The tensile force W worked on the shadow mask 60 can be calculated by the following equation.

W=Etε (1)

In equation 1, E is an elastic modulus (i.e., generally, an elastic modulus is about 210,000 N/mm²) of the shadow mask 60, t is a thickness of the shadow mask 60, ε is a strain of the shadow mask 60 caused by the tensile force W.

In addition, in consideration of major variables worked on the width D of the device for fixing the shadow mask 70, the relationship between a tensile force W worked on the shadow mask 60 and a width D of the device for fixing the shadow mask 70 can be described as below.

$$D = \sqrt{\frac{6 WH}{S}} \qquad ( 2 )$$

In equation 2, D is a width of the device for fixing the shadow mask 70, W is a tensile force worked on the shadow mask 60, S is a strength of the frit glass 80, and H is a height of the device for fixing the shadow mask 70.

Accordingly, it is possible to balance the tensile force W and the supporting force R and maintain the tensioned state of the shadow mask 60 by calculating an optimum width D of the device for fixing the shadow mask 70 in accordance with the tensile force W worked on the shadow mask 60, attaching the device for fixing the shadow mask having the optimum width D to the panel 10, and installing the shadow mask on the device for fixing the shadow mask 70.

For example, when the device for fixing the shadow mask 70 has a height H of 4.0 mm, the shadow mask has a thickness t of 0.05 mm, a strain ε of the shadow mask 60 due to a tensile force W is 0.00125, a tensile force W worked on the shadow mask 60 and a width D of the device for fixing the shadow mask 70 can be calculated as below.

W=Etε=210000(N/mm²)·0.05(mm)·0.00125=13.125(N/mm)

$$D = \sqrt{\frac{6 WH}{S}} = \sqrt{\frac{6 \cdot 13.125 ( N / mm ) \cdot 4 ( mm )}{7.46 ( N / {mm}^{2} )}} = 6.49 mm$$

In the meantime, it is preferable for the device for fixing the shadow mask 70 in accordance with the present invention to have a width D calculated by equations 1 and 2, it is also fine to have a width D in the range of 0.8 D˜1.3 D. Particularly, in determining of a width D in FIG. 3, when the device for fixing the shadow mask includes a plate having a top portion 70a, an inner portion 70b extended inwardly from the top portion and an outer bent portion 70c extended outwardly from the top portion and spaced apart from the inner portion, it is preferable for the plate of the device for fixing the shadow mask 70 to have a thickness of 0.61 mm. As depicted in FIG. 3, when a width of a first part 81 of the bonding member (e.g. frit glass) formed by leaking from a bottom of the device for fixing the shadow mask 70 in a bent side is t_{f1} and a width of a second part 82 of the bonding member (e.g. frit glass) formed by leaking from the bottom of the device for fixing the shadow mask 70 in the other side is t_{f2}, a permitted limit of t_{f1} is 1.5 mm˜2.5 mm, and a permitted limit of t_{f2} is 1 mm˜2 mm.

An actual width of the device for fixing the shadow mask 70 has to be given because of the following reasons.

In general, a little deformation can occur in the device for fixing the shadow mask 70 by the supporting force R worked on itself, in the case its strain should be less than 2 μm.

When a width D of the device for fixing the shadow mask 70 is less than 0.8 D, a strain of the device for fixing the shadow mask 70 is not less than 2 μm, accordingly the problems of the prior art such as a mislanding phenomenon of a flat CRT (Cathode Ray Tube), etc. can not be solved.

In addition, when a width D of the device for fixing the shadow mask 70 is not less than 1.3 D, a frame of a flat CRT (Cathode Ray Tube) has to increase by the increase of an area of the panel 10 due to the increase of a width of the device for fixing the shadow mask 70, accordingly area loss can be caused.

Table 1 illustrates values of a width D of the device for fixing the shadow mask 70 in accordance with variation of a thickness t of the shadow mask 60 by equation 2.

TABLE 1

| | | | | | |
|---|---|---|---|---|---|
| H(HEIGHT OF DEVICE FOR FIXING | 4.0 | 4.0 | 4.0 | 4.0 | 4.0 |
| SHADOW MASK) mm | | | | | |
| S(STRENGTH OF FRIT GLASS) N/mm² | 7.46 | 7.46 | 7.46 | 7.46 | 7.46 |
| E(ELASTIC MODULUS) N/mm² | 210000 | 210000 | 210000 | 210000 | 210000 |
| ε(STRAIN OF SHADOW MASK) | 0.00125 | 0.00125 | 0.00125 | 0.00125 | 0.00125 |
| t(THICKNESS OF SHADOW MASK) mm | 0.025 | 0.05 | 0.06 | 0.08 | 0.1 |
| W(TENSILE FORCE) N/mm | 6.5625 | 13.125 | 15.75 | 21 | 26.25 |
| D(WIDTH OF DEVICE FOR FIXING | 4.59 | 6.50 | 7.12 | 8.22 | 9.19 |
| SHADOW MASK) mm | | | | | |
| 1) 0.8 D mm | 3.68 | 5.20 | 5.69 | 6.58 | 7.35 |
| 2) 0.9 D mm | 4.14 | 5.85 | 6.41 | 7.40 | 8.27 |
| 3) 1.0 D mm | 4.59 | 6.50 | 7.12 | 8.22 | 9.19 |
| 4) 1.2 D mm | 5.51 | 7.80 | 8.54 | 9.86 | 11.03 |
| 5) 1.3 D mm | 5.97 | 8.45 | 9.25 | 10.69 | 11.95 |

Next, table 2 illustrates values of a width D of the device for fixing the shadow mask 70 in accordance with variation of a strain ε of the shadow mask 60 by equation 2.

TABLE 2

| | | | | | |
|---|---|---|---|---|---|
| H(HEIGHT OF DEVICE FOR FIXING | 4.0 | 4.0 | 4.0 | 4.0 | 4.0 |
| SHADOW MASK) mm | | | | | |
| S(STRENGTH OF FRIT GLASS) N/mm² | 7.46 | 7.46 | 7.46 | 7.46 | 7.46 |
| E(ELASTIC MODULUS OF FLIT GLASS) | 210000 | 210000 | 210000 | 210000 | 210000 |
| N/mm² | | | | | |
| ε(STRAIN OF SHADOW MASK) | 0.001 | 0.00125 | 0.0013 | 0.00135 | 0.0014 |
| t(THICKNESS OF SHADOW MASK) mm | 0.05 | 0.05 | 0.05 | 0.05 | 0.05 |
| W(TENSILE FORCE) N/mm | 10.5 | 13.125 | 13.65 | 14.175 | 14.7 |
| D(WIDTH OF DEVICE FOR FIXING | 5.81 | 6.50 | 6.63 | 6.75 | 6.88 |
| SHADOW MASK) | | | | | |
| 1) 0.8 D | 4.65 | 5.20 | 5.30 | 5.40 | 5.50 |
| 2) 0.9 D | 5.23 | 5.85 | 5.96 | 6.08 | 6.19 |
| 3) 1.0 D | 5.81 | 6.50 | 6.63 | 6.75 | 6.88 |
| 4) 1.2 D | 6.97 | 7.80 | 7.95 | 8.10 | 8.25 |
| 5) 1.3 D | 7.56 | 8.45 | 8.61 | 8.78 | 8.94 |

In the meantime, as the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the meets and bounds of the claims or equivalencies of such meets and bounds are therefore intended to be embraced by the appended claims.

FIG. 4 is a sectional view illustrating a device for fixing a shadow mask of a flat CRT in accordance with another embodiment of the present invention. A L-shaped device for fixing a shadow mask 71 can fixed to the panel 10 by a frit glass 80 coated on a bottom surface of the device for fixing the shadow mask 71 and a upper surface of the panel 10.

A width D of the device for fixing the shadow mask 71 in accordance with the another embodiment of the present invention is determined according to a tensile force W, a value of the width D can be varied within the above-described permitted limit.

As described above, in a device for fixing a shadow mask installed between a shadow mask and a panel of a flat CRT (Cathode Ray Tube) and maintaining a constant distance between the shadow mask and panel, a width of the device for fixing the shadow mask can be changed in accordance with its height and a tensile force worked on the shadow mask.

In addition, in the present invention, an optimum width of a device for fixing a shadow mask can be calculated in accordance with a tensile force worked on the shadow mask and a height of a device for fixing a shadow mask itself, and also a permitted limit of an optimum width of the device for fixing the shadow mask can be calculated.

Accordingly, a device for fixing a shadow mask in accordance with the present invention can prevent a mislanding phenomenon (i.e., colors of a picture are changed or mixed) due to position change of a plurality of holes formed on the shadow mask.

In addition, the present invention can prevent a crack in a frit glass which can be a cause of defective product.

What is claimed is:

1. A device for fixing a shadow mask placed between a panel and a shadow mask of a flat CRT (Cathode Ray Tube) and adhered to the panel by a bonding member so as to maintain a constant distance between the panel and the shadow mask, wherein a width D of a panel-adhered portion of the device is determined by an equation
$$D = \sqrt{\frac{6 WH}{S}} ,$$
and a permitted limit of the width D is 0.8 D˜1.3 D wherein W is a tensile force applied to the shadow mask, S is a strength of a bonding member and H is a height of the device itself.

2. The device of claim 1, wherein the bonding member is a frit glass.

3. The device of claim 2, wherein the device for fixing the shadow mask includes a plate having a top portion, an inner portion extended inwardly from said top portion and an outer bent portion extended outwardly from said top portion and spaced apart from said inner portion and said plate has a thickness of 0.61 mm.

4. The device of claim 3, wherein a width of a first part of the bonding member formed by leaking from the bottom of the plate in a bent side of the device for fixing the shadow mask is t_{f1} and a width of a second part of the bonding member formed by leaking from the bottom of the plate in the other side of the device for fixing the shadow mask is t_{f2}, a permitted limit of t_{f1} is 1.5 mm˜2.5 mm, and a permitted limit of t_{f2} is 1 mm˜2 mm.

5. The device of claim 1, wherein the device for fixing the shadow mask includes a plate having a top portion, an inner portion extended inwardly from said top portion and an outer bent portion extended outwardly from said top portion and spaced apart from said inner portion and said plate has a thickness of 0.61 mm.

6. The device of claim 5, wherein a width of a first part of the bonding member formed by leaking from the bottom of the plate in a bent side of the device for fixing the shadow mask is t_{f1} and a width of a second part of the bonding member formed by leaking from the bottom of the plate in the other side of the device for fixing the shadow mask is t_{f2}, a permitted limit of t_{f1} is 1.5 mm˜2.5 mm, and a permitted limit of t_{f2} is 1 mm˜2 mm.
